(19) United States
(12) Patent Application Publication
(10) Pub. No.: US 2020/0406196 A1
(43) Pub. Date: Dec. 31, 2020

(54) HOLLOW FIBER LIQUID FILTER DEVICE PROVIDED WITH EXHAUST FIBER MEMBRANES AND USE METHOD OF HOLLOW FIBER LIQUID FILTER DEVICE

(71) Applicant: Shenzhen tubi environmental technology Co.,ltd, SHENZHEN (CN)

(72) Inventors: Yiqiang Yang, Chongqing (CN); Fu Hu, Daying (CN); Lin Su, Hengxian (CN)

(21) Appl. No.: 17/019,393

(22) Filed: Sep. 14, 2020

(30) Foreign Application Priority Data
Aug. 5, 2020 (CN) 202010776204.X

(51) Int. Cl. B01D 63/04; B01D 69/08; B01D 19/00; C02F 1/20; B01D 65/02

(52) U.S. Cl. CPC B01D 63/043; B01D 69/08; B01D 19/0031; C02F 1/20; C02F 2303/04; B01D 2313/04; C02F 2303/16; B01D 2321/04; B01D 65/02

(57) ABSTRACT

The disclosure provides a hollow fiber liquid filter device provided with exhaust fiber membranes. The hollow fiber liquid filter device comprises a shell, a liquid inlet end, a liquid outlet end, a melt-blown fiber filter element, a hollow fiber liquid filtering part and a hollow fiber gas filtering part, wherein the liquid inlet end and the liquid outlet end are respectively connected to the upper end and the lower end of the shell, the melt-blown fiber filter element is arranged on the inner side of the shell, the hollow fiber liquid filtering part and the hollow fiber gas filtering part are respectively arranged on the inner side of the melt-blown fiber filter element, a liquid inlet is formed in the liquid inlet end, and ,a liquid outlet is formed in the liquid outlet end.

### TECHNICAL FIELD

The disclosure relates to the technical field of liquid filtration, in particular to a hollow fiber liquid filter device, provided with exhaust fiber membranes, with an exhaust function, and further relates to a liquid filtering method of the hollow fiber liquid filter device provided with exhaust fibers. The device may operate by means of low-pressure suction force generated by the mouth of a user or other suction tools.

### BACKGROUND

Hollow fiber liquid filtration technology is used in a variety of water filter devices, including industrial water filter devices, home filter devices and personal filter devices.

The existing hollow fiber liquid filter membranes encounter a general problem in the use process that hollow fiber liquid filter membranes depending on low-pressure or non-pressure suction force need to be used in personal filter devices or outdoor emergency filter devices, but the hollow fiber liquid filter membranes have hydrophilicity; when the membrane walls of the membranes with hydrophilicity are in a wet state after being in contact with water air is difficult to penetrate through the membrane walls or even cannot penetrate through the membrane walls, and a problem for the use method of the maximum contact surfaces of the membranes occurs (the exteriors of the membranes are in contact with liquid, and the liquid penetrates through, the membrane walls to enter the inner cavities of the membranes to be filtered) in use; and air in the device cannot be discharged normally and is retained in the device, so that the air can prevent liquid from flowing, and the phenomena that the device is difficult to discharge water and, even does not discharge water can be caused.

In order to solve the problem, many such products adopt a method that the filter membranes are used in the reverse direction (the inner cavities of the membranes are used for absorbing water, and the liquid enters the exteriors of the membranes through the membrane walls). Although the method effectively solves the problem of air retention in the device, the use method can cause the inner cavities of the membranes to be easily blocked by particles in water, so that the service life of the membrane is greatly shortened, and the flow amount of water in the device is influenced; and moreover, some hard particle impurities enter the inner cavities of the hollow fiber membranes and easily scratch the membrane walls under the flowing of liquid, so that the filter device instantly loses efficacy. In this way, the problems that the service life of the device is short and the filtering reliability cannot be guaranteed in the use process are solved.

### SUMMARY

The disclosure aims to provide a hollow, fiber liquid filter device provided with exhaust fiber membranes and a use method of the hollow fiber liquid filter device so as to solve the problem proposed in the background.

In order to achieve the above purpose, the disclosure provides the following technical scheme:

The hollow fiber liquid filter device provided with the exhaust fiber membranes comprises a shell, a liquid inlet end, a liquid outlet end, a melt-blown fiber filter element, a hollow fiber liquid filtering part comprising hollow fiber gas filter membranes for only liquid to go through micropores in a wet state, and a hollow fiber gas, filtering part comprising hollow fiber gas filter membranes for only gas to go through micropores in the wet state; the liquid inlet end and the liquid outlet end are respectively connected to the upper end and the lower end of the shell, the melt-blown fiber filter element is arranged on the inner side of the shell, the hollow fiber liquid filtering part and the hollow fiber gas filtering part are respectively arranged on the inner side of the melt-blown fiber filter element, a liquid inlet is formed in the liquid inlet end, and a liquid outlet is formed in the liquid outlet end. Here, the hollow fiber gas filter membranes are used, the characteristic of the membranes lies in that, in the wet state, only gas can, pass through the micropores but liquid cannot pass through the micropores in the membranes; the hollow fiber gas filter membranes are added, so that gas retained in the device can be discharged on the premise of not using the hollow fiber liquid filter membranes in the reverse direction, and liquid can be effectively filtered through the membrane walls; and intercepted particles are intercepted on the outer walls of the membranes, so that the membranes are easy to clean. The melt-blown fiber filter element is further added in the device, the filter element is provided with granular particles which can be seen by naked eyes in, water, large-particle impurities are preliminarily filtered through the filter element, the impurities with large particles in liquid are blocked on the outer wall of the melt-blown fiber filter element, and the risk that the large-particle impurities scratch the hollow fiber membranes in the flowing process of the liquid is also greatly reduced.

Preferably, the upper end of the melt-blown fiber filter element is fixedly connected with the inner wall of the upper end of the shell through a supporting part in a supporting mode, the outer side of the supporting part is fixedly connected with the inner wall of the shell in a sealed mode, the upper end of the melt-blown fiber filter element is fixedly connected with the supporting part in an embedded mode, a sealing part is arranged at the lower end of the melt-blown fiber filter element and fixedly seals an opening in the lower end of the melt-blown fiber filter element, a U-shaped isolation cavity is formed by the shell and the melt-blown fiber filter element through the sealing part and the supporting part, liquid flows in from the liquid inlet and enters the U-shaped isolation cavity between the melt-blown fiber filter element and the shell, after the liquid is filtered by the pipe wall of the melt-blown fiber filter element, the liquid enters the inner side of the cylinder wall of the melt-blown fiber filter element, and then the liquid is filtered by the hollow fiber liquid filter membranes and the hollow fiber gas filter membranes in the next step.

Preferably, the hollow fiber gas filtering part comprises a gas filtering hollow, fiber bundle composed of, a plurality of hollow fibers for filtering gas, and the two ends of the gas filtering hollow fiber bundle respectively penetrate through the supporting part from bottom to top from the inner side of the melt-blown fiber filter element in the sealed mode; each hollow fiber for filtering gas is bent, the two ends of each hollow fiber are embedded in the supporting part in the sealed mode, hollow openings in the two ends face the upper end of the supporting part to form capillary gas outlet holes, a separation cavity is formed by an interval space between each hollow fiber for filtering gas and the melt-blown fiber filter element, and micropores are formed in the membrane wall of each fiber membrane; bent annular parts of the hollow fibers for filtering gas face the liquid inlet, the gas on the inner side of the cylinder wall of the melt-blown fiber filter element enters the hollow inner cavities of the fibers through the micropores in the fiber membrane walls and flows to the capillary gas outlet holes of the fibers, and the gas in the capillary gas outlet holes is converged to the liquid outlet in the liquid outlet end. Here, the hollow fiber gas filtering part of the device comprises only one bundle of hollow fiber gas filter membranes which are hermetically connected and supported with the shell and the melt-blown fiber filter element by resin in, a bent mode to form a sealed supporting part, so that the two ends of each fiber are hermetically embedded in the supporting part, small holes formed by openings in the two ends of the fibers and the supporting part serve as gas outlets of the fiber membranes, a separation cavity is formed by an interval space between every two fibers, micropores are formed in the membrane wall of each fiber membrane, and characteristic of the fiber membranes lies in that only gas can pass through the micropores in the wet state, but, liquid cannot pass through the micropores. The bent annular parts of the fiber membranes face the liquid inlet, liquid enters the separation cavities through the inlet and the melt-blown fiber filter element, the liquid extrudes gas to enter the inner cavities of the fiber membranes through, the micropores in the walls of the fiber membranes, the gas flows out of the inner cavities to the gas outlets of the fiber membranes, and the gas at the multiple gas outlets flows to the liquid outlet of the device to be collected to exhaust air in the separation cavities; the air cannot prevent the liquid from flowing, so that the liquid effectively flows to the hollow fiber liquid filter membranes through the separation cavities. Here, while the supporting part is embedded in the hollow fiber liquid filtering part, the hollow fiber gas filtering part is added, and by utilizing the characteristic that only gas can be allowed to pass through the filter membranes of the hollow fiber gas filtering part but liquid cannot be allowed to pass through the filter membranes of the hollow fiber gas filtering part in the wet state, the defect of hydrophilicity of the hollow fiber liquid filtering part is overcome, namely, air is difficult to pass through the membrane walls or even cannot pass through the membrane walls in the wet state after the membrane walls are in contact with water, so that the problem that the device cannot exhaust air retained in the separation cavities is solved.

Preferably, the hollow fiber liquid filtering part comprises a liquid filtering hollow fiber bundle composed of a plurality of hollow fibers for filtering liquid, and the two ends of the gas filtering hollow fiber bundle, respectively penetrate through the supporting part from bottom to top from the inner side of the melt-blown fiber filter element in the sealed mode; each hollow fiber for filtering liquid is bent, the two ends of each hollow fiber are embedded in the supporting part in the sealed mode, hollow openings in the two ends face the upper end of the supporting part to form capillary liquid outlet holes, a separation cavity is formed by an interval space between each hollow fiber for filtering liquid and the melt-blown fiber filter element, and micropores are formed in the membrane wall of each fiber membrane; bent annular parts of the hollow fibers for filtering liquid face the liquid inlet, the liquid entering the inner side of the cylinder wall of the melt-blown fiber filter element enters the hollow inner cavities of the fibers through the micropores in the fiber membrane walls and flows to the capillary liquid outlet holes of the fibers, and then the liquid in the capillary liquid outlet holes is converged to the liquid outlet in the liquid outlet end. Here, the device comprises only one bundle of hollow fiber liquid filter membranes, and the shell and the melt-blown fiber filter element of the device are hermetically connected and supported by resin to form a sealed, supporting part. The hollow fiber liquid filter membranes have hydrophilicity, and the characteristic of hydrophilicity lies in that liquid and gas can pass through the micropores in a dry state, only the liquid can pass through the micropores in the wet state. but the gas cannot pass through the micropores. Here, the curved annular parts of the hollow fiber liquid filter membranes and the hollow fiber gas filter membranes face the liquid inlet to increase the contact area of the membranes with liquid and gas to achieve maximum throughput.

Preferably, the supporting part is manufactured by resin curing, and is integrally connected with the liquid filtering hollow fiber bundle and the gas filtering hollow fiber bundle in a solidified mode; and a manufacturing method of the supporting part comprises the steps of embedding liquefied resin in the two ends of the liquid filtering hollow fiber bundle and the two ends of the gas filtering hollow fiber bundle after bending the liquid filtering hollow fiber bundle and the gas filtering hollow fiber bundle respectively, cutting off tail ends after resin curing to expose capillary holes of the hollow fibers, and then manufacturing the liquid filtering hollow fiber bundle and the gas filtering hollow fiber bundle into sizes and shapes matched with the shell and the melt-blown fiber filter element. Here, after the hollow fibers are bent, both ends are embedded in the supporting part, thereby forming a loop shape. The annular parts face the liquid inlet. A separation cavity is formed by the space between the fibers and the inner wall of the melt-blown fiber filter element. The liquid filter membranes and the gas filter membranes are embedded into the supporting part by the same method.

Preferably, the liquid outlet end of the filter device is set to be a liquid outlet nozzle, and the liquid outlet nozzle can be used by a user to suck through the mouth or be connected with an external suction device, so that suction force is provided for the filter device, and sucked liquid passes through the filter device.

Preferably, the internal fibers of the melt-blown fiber filter element comprise a plurality of antibacterial fibers, so that the propagation of microorganisms can be effectively prevented, and the microorganisms comprise bacteria. By intercepting microorganisms and inhibiting the growth of the microorganisms, the propagation of bacteria in the separation cavity between the melt-blown fiber filter element and the hollow fiber liquid filtering part can be inhibited, so that the microorganisms are inactivated, and an, antibacterial effect is achieved.

In order to better achieve the effect of the disclosure, there is also provided a use method of a hollow fiber liquid filter device with the exhaust fiber membranes, comprising the following steps:

S1, insertion: inserting the liquid inlet end of the hollow fiber liquid filter device provided with the exhaust fiber membranes into liquid needing to be filtered;

S2, primary filtration: communicating the mouth of the user or the external suction device with the liquid outlet in the liquid outlet end and providing negative pressure, and enabling liquid to enter the U-shaped isolation cavity between the melt-blown fiber filter element and the shell from the liquid inlet and to pass through the side wall of the melt-blown fiber filter element;

S3, gas filtration: enabling liquid through primary filtration to enter the separation cavity between the melt-blown fiber filter element and the hollow fiber gas filtering part, enabling gas in the separation cavity to pass through the micropores in the membrane walls of the hollow fiber gas filter membranes under the action of suction force and enter the inner cavities of the hollow fiber gas filter membranes, and discharging the liquid from the liquid outlet nozzle, so that the gas does not generate resistance to flow of the liquid;

S4, liquid filtration: after the gas is discharged, enabling the liquid to pass through the micropores in the membrane walls of the hollow, fiber liquid filter membranes from the separation cavity between the melt-blown fiber filter element and the hollow fiber liquid filtering part under the action of suction force and enter the inner cavities of the hollow fiber liquid filter membranes, and blocking the microorganisms and the bacteria in the liquid outside the membrane walls without entering the inner cavities of the hollow fiber liquid filter membranes by utilizing the micropores in the membrane walls of the hollow fiber liquid filter membranes, so that filtration is completed; and

S5, discharging: discharging the liquid from the capillary liquid outlet holes in the liquid filtering hollow fiber bundle composed of a plurality of hollow fibers for filtering liquid in the hollow fiber liquid filtering part and converging the liquid to be discharged from the liquid outlet in the liquid outlet end so as to be drunk or collected and stored by the user.

In order to enable the device to keep clean and sanitary, the use method further comprises a back-flushing step, before filtration is ended, positive pressure is provided for the liquid outlet nozzle in a manner of blowing by the user or reversing by the external suction device and the like, and the liquid impacts the liquid filtering hollow fibers from the liquid outlet through the capillary liquid outlet holes, so that back flushing of the liquid filtering hollow fibers and the melt-blown fiber filter element is realized by clean liquid.

Furthermore, when the device is not used, the user can blow water left in the device out of the liquid inlet through an air blowing method, and the water can also be thrown out of the device through a swinging action.

Preferably, the liquid is water comprising particles and micrograms.

Compared with the prior art, the hollow fiber liquid filter device provided with the exhaust fiber membranes and the use method of the hollow fiber liquid filter device have the beneficial effects that, through effective arrangement of the melt-blown fiber filter element, the hollow fiber liquid filtering part, the hollow fiber gas filtering part and the like, the water filter device solves the problems that gas stays in the device to influence and stop liquid flowing, large fruit grains influence the service life of hollow fibers and the like, is smooth in exhaust and has the characteristics of high water permeability, convenience in use, durability, sanitation, health, cleanness, bacteriostasis and the like, the maintenance difficulty of the water filter device is greatly reduced, and the water filter device is suitable for various occasions such as field multi-person or single-person water taking and direct drinking.

### BRIEF DESCRIPTION OF THE DRAWINGS

FIG. 1 is a diagrammatic cross-section of the embodiment of the disclosure;

Wherein, 1, shell, 2, liquid inlet end, 3, liquid outlet end, 4, melt-blown fiber filter element, 5, liquid inlet, 6, liquid outlet nozzle, 7, supporting part, 8, sealing part, 9, U-shaped isolation cavity, 10, gas filtering hollow fiber bundle, and 11, liquid filtering hollow fiber bundle.

### DESCRIPTION OF THE EMBODIMENTS

The following clearly and completely describes the technical scheme in the embodiments of the disclosure with reference to the accompanying drawings in the embodiments of the disclosure. Apparently, the described embodiments are merely a part rather than all of the embodiments of the disclosure. Based on the embodiment in the disclosure, all other embodiments obtained by the ordinary technical staff in the art under the premise of without contributing, creative labor belong to the scope protected by the disclosure.

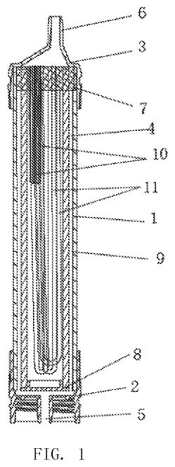

Referring to FIG. 1, the hollow fiber liquid filter device provided with the exhaust fiber membranes comprises a shell 1, a liquid inlet end 2, a liquid outlet end 3, a melt-blown fiber filter element 4, a hollow fiber liquid filtering part comprising hollow fiber gas filter membranes for only liquid to go through micropores in a wet state, and a hollow fiber gas filtering part comprising hollow fiber gas filter membranes for only gas to go through micropores in the wet state; the liquid inlet 2 end and the liquid outlet end 3 are respectively connected to the upper end and the lower end of the shell 1, the melt-blown fiber filter element 4 is arranged on the inner side of the shell 1, the hollow fiber liquid filtering, part and the hollow fiber gas filtering part are respectively arranged on the inner side of the melt-blown fiber filter element 4, a liquid inlet 5 is formed in the, liquid inlet end 2, and a liquid outlet is formed in the liquid outlet end 3. Here, the hollow fiber gas filter membranes are used, the characteristic of the membranes lies in that, in the wet state, only gas can pass through the micropores but liquid cannot pass through the micropores in the membranes; the hollow fiber gas filter membranes are added, so that gas retained in the device can be discharged on the premise of not using the hollow fiber liquid filter membranes in the reverse direction, and liquid can be effectively filtered through the membrane walls; and intercepted particles are intercepted on the outer walls of the membranes, so that the membranes are easy to clean. The melt-blown fiber filter element 4 is further added in the device, the filter element is provided with granular particles which can be seen by naked eyes in water, large-particle impurities are preliminarily filtered through the filter element, the impurities with large particles in liquid are blocked on the outer wall of the melt-blown fiber filter element 4, and the risk that the large-particle impurities scratch the hollow fiber membranes in the flowing process of the liquid is also greatly reduced.

The upper end of the melt-blown fiber filter element 4 is fixedly connected with the inner wall of the upper end of the shell 1 through a supporting part 7 in a supporting mode, the outer side of the supporting part 7 is fixedly connected with the inner wall of the shell 1 in a sealed mode, the upper end of the melt-blown fiber filter element 4 is fixedly connected with the supporting part 7 in an embedded mode, a sealing part 8 is arranged at the lower end of the melt-blown fiber filter element 4 and fixedly seals an opening in the lower end of the melt-blown fiber filter element 4, a U-shaped isolation cavity 9 is formed by the shell 1 and the melt-blown fiber filter element 4 through the sealing part 8 and the supporting part 7, liquid flows in from the liquid inlet 5 and enters the U-shaped isolation cavity 9 between the melt-blown fiber filter element 4 and the shell 1, after the liquid is filtered by the pipe wall of the melt-blown, fiber filter element 4, the liquid enters the inner side of the cylinder wall of the melt-blown fiber filter element 4, and then the liquid is filtered by the hollow fiber liquid filter membranes and the hollow fiber gas filter membranes in the next step.

The hollow fiber gas filtering part comprises a gas filtering hollow fiber bundle 10 composed of, a plurality of hollow fibers for filtering gas, and the two ends of the gas filtering hollow fiber bundle 10 respectively penetrate through the supporting part 7 from bottom to top from the inner side of the melt-blown fiber filter element 4 in the sealed mode; each hollow, fiber for filtering gas is bent, the two ends of each hollow fiber are embedded in the supporting part 7 in the sealed mode, hollow openings in the two ends face the upper end of the supporting part 7 to form capillary gas outlet holes, a separation cavity is formed by an interval space between each hollow fiber for filtering gas and the melt-blown fiber filter element 4, and micropores are formed in the membrane wall of each fiber membrane; bent annular parts of the hollow fibers, for filtering gas face the liquid inlet 5, the gas on the inner side of the cylinder wall of the melt-blown fiber filter element 4 enters the hollow inner cavities of the fibers through the micropores in the fiber membrane walls and flows to the capillary gas outlet holes of the fibers, and the gas in the capillary gas outlet holes is converged to the liquid outlet in the liquid outlet end 3.

The hollow fiber liquid filtering part comprises a liquid filtering hollow fiber bundle 11 composed of a plurality of hollow fibers for filtering liquid, and the two ends of the gas filtering hollow fiber bundle 11 respectively penetrate through the supporting part 7 from bottom to top from the inner side of the melt-blown fiber filter element 4 in the sealed mode; each hollow, fiber for filtering liquid is bent the two ends of each hollow fiber are embedded in the supporting part 7 in the sealed mode, hollow openings in the two ends face the upper end of the supporting part 7 to form capillary liquid outlet holes, a separation cavity is formed by an interval space between each hollow fiber for filtering liquid and the melt-blown fiber filter element 4, and micropores are formed in the membrane wall of each fiber membrane; bent annular parts of the hollow fibers for filtering liquid face the liquid inlet 5, the liquid entering the inner side of the cylinder wall of the melt-blown fiber filter element 4 enters the hollow inner cavities of the fibers through the micropores in the fiber membrane walls and flows to the capillary liquid outlet holes of the fibers, and then the liquid in the capillary liquid outlet holes is converged to the liquid outlet in the liquid outlet end 3.

The supporting part 7 is manufactured by resin curing, and is integrally connected with the liquid filtering, hollow fiber bundle 11 and the gas filtering hollow fiber bundle 10 in a solidified mode; and a manufacturing method of the supporting part comprises the steps of embedding liquefied resin in the two ends of the liquid filtering hollow fiber bundle and the two ends of the gas filtering hollow fiber bundle after bending the liquid filtering hollow fiber bundle 11 and the gas filtering hollow fiber bundle 10 respectively, cutting off tail ends after resin curing to expose capillary holes of the hollow fibers, and then manufacturing the liquid filtering hollow fiber bundle and the gas filtering hollow fiber bundle into sizes and shapes matched with the shell 1 and the melt-blown fiber filter element 4.

The liquid outlet end 3 of the filter device is set to be a liquid outlet nozzle 6, and the liquid outlet nozzle 6 can be used by a user to suck through the mouth or be connected with an external suction device, so that suction force is provided for the filter device, and sucked liquid passes through the filter device.

The internal fibers of the melt-blown fiber filter element 4 comprise a plurality of antibacterial fibers, so that the propagation of microorganisms can be effectively prevented, and the microorganisms comprise bacteria.

In order to better achieve the effect of the disclosure, there is also provided a use method of a hollow fiber liquid filter device with the exhaust fiber membranes, comprising the following steps:

S1, insertion: inserting the liquid, inlet end 2 of the hollow fiber liquid filter device provided with the exhaust fiber membranes into liquid needing to be filtered;

S2, primary filtration: communicating the mouth of the user or the external suction device with the liquid outlet in the liquid outlet end 3 and providing negative pressure, and enabling liquid to enter the U-shaped isolation cavity 9 between the melt-blown fiber filter element 4 and the shell 1 from the liquid inlet 5 and to pass through the side wall of the melt-blown fiber filter element 4;

S3, gas filtration: enabling liquid through primary filtration to enter the separation cavity between the melt-blown fiber filter element 4 and the hollow fiber gas filtering part, enabling gas in the separation cavity to pass through the micropores in the membrane walls of the hollow fiber gas filter membranes under the action of suction force and enter the inner cavities of the hollow fiber gas filter membranes, and discharging the liquid from the liquid outlet nozzle 6, so that the gas does not generate resistance to flow of the liquid;

S4, liquid filtration: after the gas is discharged, enabling the liquid to pass through the micropores in the membrane walls of the hollow fiber liquid filter membranes from the separation cavity between the melt-blown fiber filter element 4 and the hollow fiber liquid filtering part under the action of suction force and enter the inner cavities of the hollow fiber liquid filter membranes, and blocking the microorganisms and the bacteria in the liquid outside the membrane walls without entering the inner cavities of the hollow fiber liquid filter membranes by utilizing the micropores in the membrane walls of the hollow fiber liquid filter membranes, so that filtration is completed; and

S5, discharging: discharging the liquid from the capillary liquid outlet holes in the liquid filtering hollow fiber bundle 11 composed of a plurality of hollow fibers for filtering liquid in the hallow fiber liquid filtering part, and converging the liquid to be discharged from the liquid outlet in the liquid outlet end 3 so as to be drunk or collected and stored by the user.

The use method further comprises a back-flushing step, before filtration is ended, positive pressure is provided for the liquid outlet nozzle 6 in a manner of blowing by the user or reversing by the external suction device and the like, and the liquid impacts the liquid filtering hollow fibers from the liquid outlet through the capillary liquid outlet holes, so that back flushing of the liquid filtering hollow fibers and the melt-blown fiber filter element 4 is realized by clean liquid.

When the device is not used, the user can, blow water left in the device out of the liquid inlet through an air blowing, method, and the water can also be thrown out of the device through a swinging action.

The liquid is water comprising particles and micrograms.

Although the embodiments of the disclosure have already been illustrated and described, various changes, modifications, replacements and transformations can be made by any person skilled in the art under the condition of without departing from the principle and the spirit of the disclosure, and thus the scope of the disclosure should be restricted by claims and equivalents thereof.

What is claimed is:

1. A hollow fiber liquid filter device provided with exhaust fiber membranes, characterized in that the hollow fiber liquid filter device comprises a shell, a liquid inlet end, a liquid outlet end, a melt-blown fiber filter element, a hollow, fiber liquid filtering part comprising hollow fiber gas filter membranes for only liquid to go through micropores in a wet state, and a hollow fiber gas filtering part comprising hollow fiber gas filter membranes for only gas to go through micropores in the wet state; the liquid inlet end and the liquid outlet end are respectively connected to the upper end and the lower end of the shell, the melt-blown fiber filter element is arranged on the inner side of the shell, the hollow fiber liquid filtering part and the hollow fiber gas filtering part are respectively arranged on the inner side of the melt-blown fiber filter element, a liquid inlet is formed in the liquid inlet end, and a liquid outlet is formed in the liquid outlet end.

2. The filter device according to the claim 1, characterized in that the upper end of the melt-blown fiber filter element is fixedly connected with the inner wall of the upper end of the shell through a supporting part in a supporting mode, the outer side of the supporting part is fixedly connected with the inner wall of the shell in a sealed mode, the upper end of the melt-blown fiber filter element is fixedly connected with the supporting part in an embedded mode, a sealing part is arranged at the lower end of the melt-blown fiber filter element and fixedly seals an opening in the lower end of the melt-blown fiber filter element, a U-shaped isolation cavity is formed by the shell and the melt-blown fiber filter element through the sealing part and the supporting part, liquid flows in from the liquid inlet and enters the U-shaped isolation cavity between the melt-blown fiber filter element and the shell, after the liquid is filtered by the pipe wall of the melt-blown fiber filter element, the liquid enters the inner side of the cylinder wall of the melt-blown fiber filter element, and then the liquid is filtered by the hollow fiber liquid filter membranes and the hollow fiber gas filter membranes in the next step.

3. The filter device according to claim 2, characterized in that the hollow fiber gas filtering part comprises a gas filtering hollow fiber bundle composed of a plurality of hollow fibers for filtering gas, and the two ends of the gas filtering hollow fiber bundle respectively penetrate through the supporting part from bottom to top from the inner side of the melt-blown fiber filter element in the sealed mode; each hollow fiber for filtering gas is bent, the two ends of each hollow fiber are embedded in the supporting part in the sealed mode, hollow openings in the two ends face the upper end of the supporting part to faun capillary gas outlet holes, a separation cavity is formed by an interval space between each hollow fiber for filtering gas and the melt-blown fiber filter element, and micropores are formed in the membrane wall of each fiber membrane; bent annular parts of the hollow fibers for filtering gas face the liquid inlet, the gas on the inner side of the cylinder wall of the melt-blown fiber filter element enters the hollow inner cavities of the fibers through the micropores in the fiber membrane walls and flows to the capillary gas outlet holes of the fibers, and the gas in the capillary gas outlet holes is converged to the liquid outlet in the liquid outlet end.

4. The fiber device according to claim 3, characterized in that the hollow fiber liquid filtering part comprises a liquid filtering hollow fiber bundle composed of a plurality of hollow fibers for filtering liquid, and the two ends of the liquid filtering hollow fiber bundle respectively penetrate through the supporting part from bottom to top from the inner side of the melt-blown fiber filter element in the sealed mode; each hollow fiber for filtering liquid is bent, the two ends of each hollow fiber are embedded in the supporting part in the sealed mode, hollow openings in the two ends face the upper end of the supporting part to form capillary liquid outlet holes, a separation cavity is formed by an interval space between each hollow fiber for filtering liquid and the melt-blown fiber filter element, and micropores are formed in the membrane wall of each fiber membrane; bent annular parts of the hollow fibers for filtering liquid, face the liquid inlet, the liquid entering the inner side of the cylinder wall of the melt-blown fiber filter element enters the hollow inner cavities of the fibers through the micropores in the fiber membrane walls and flows to the capillary liquid outlet holes of the fibers, and then the liquid in the capillary liquid outlet holes is converged to the liquid outlet in the liquid outlet end.

5. The filter device according to claim 1, characterized in that the supporting part is manufactured by resin curing, and is integrally connected with the liquid filtering hollow fiber bundle and the gas filtering hollow fiber bundle in a solidified mode; and a manufacturing method of the supporting part comprises the steps of embedding liquefied resin in the two ends of the liquid filtering hollow fiber bundle and the two ends of the gas filtering hollow fiber bundle after bending the liquid filtering hollow fiber bundle and the gas filtering hollow fiber bundle respectively, cutting off tail ends after resin curing to expose capillary holes of the hollow fiber, and then manufacturing the liquid filtering, hollow fiber bundle and the gas filtering hollow fiber bundle into sizes and shapes matched with the shell and the melt-blown fiber filter element.

6. The filter device according to claim 2, characterized in that the supporting part is manufactured by resin curing, and is integrally connected with the liquid filtering hollow fiber bundle and the gas filtering hollow fiber bundle in a solidified mode; and a manufacturing method of the supporting part comprises the steps of embedding liquefied resin in the two ends of the liquid filtering hollow fiber bundle and the two ends of the gas filtering hollow fiber bundle after bending the liquid filtering hollow fiber bundle and the gas filtering hollow fiber bundle respectively, cutting off tail ends after resin curing to expose capillary holes of the hollow fiber, and then manufacturing the liquid filtering hollow fiber bundle and the gas filtering hollow fiber bundle into sizes and shapes matched with the shell and the melt-blown fiber filter element.

7. The filter device according to claim 3, characterized in that the supporting part is manufactured by resin curing, and is integrally connected with the liquid filtering hollow fiber bundle and the gas filtering hollow fiber bundle in a solidified mode; and a manufacturing method of the supporting part comprises the steps of embedding liquefied resin in the two ends of the liquid filtering hollow fiber bundle and the two ends of the gas filtering hollow fiber bundle after bending the liquid filtering hollow fiber bundle and the gas filtering hollow fiber bundle respectively, cutting off tail ends after resin curing to expose capillary holes of the hollow fiber, and then manufacturing the liquid filtering hollow fiber bundle and the gas filtering hollow fiber bundle into sizes and shapes, matched with the shell and the melt-blown fiber filter element.

8. The filter device according to claim 4, characterized in that the supporting part is manufactured by resin curing, and is integrally connected with the liquid filtering hollow fiber bundle and the gas filtering hollow fiber bundle in a solidified mode; and a manufacturing method of the supporting part comprises the steps of embedding liquefied resin in the two ends of the liquid filtering hollow fiber bundle and the two ends of the gas filtering hollow fiber bundle after bending the liquid filtering hollow fiber bundle and the gas filtering hollow fiber bundle respectively, cutting off tail ends after resin curing to expose capillary holes of the hollow fiber, and then manufacturing the liquid filtering hollow fiber bundle and the gas filtering hollow fiber bundle into sizes and shapes matched with the shell and the melt-blown fiber filter element.

9. The filter device according to claim 5, characterized in that the liquid outlet end of the filter device is set to be a liquid outlet nozzle, and the liquid outlet nozzle can be used by a user to suck through the mouth or be connected with an external suction device, so that suction force is provided for the filter device, and sucked liquid passes through the filter device.

10. The filter device according to claim 5, characterized in that the internal fibers of the melt-blown fiber filter element comprise a plurality of antibacterial fibers, the propagation of microorganisms can be prevented effectively, and the microorganisms comprise bacteria.

11. A use method of the filter device according to claim 1, characterized by comprising the following steps:
S1, insertion: inserting the liquid inlet end of the hollow fiber liquid filter device provided with the exhaust fiber membranes into liquid needing to be filtered;
S2, primary filtration: communicating the mouth of the user or the external suction device with the liquid outlet in the liquid outlet end and providing negative pressure, and enabling liquid to enter the U-shaped isolation cavity between the melt-blown fiber filter element and the shell from the liquid inlet and to pass through the side wall of the melt-blown fiber filter element;
S3, gas filtration: enabling liquid through primary filtration to enter the separation cavity between the melt-blown fiber filter element and the hollow fiber gas filtering part, enabling gas in the separation cavities to pass through the micropores in the membrane walls of the hollow fiber gas filter membranes under the action of suction force and enter the inner cavities of the hollow, fiber gas filter membranes, and discharging the liquid from the liquid outlet nozzle, so that the gas does not generate resistance to flow of the liquid;
S4, liquid filtration: after the gas is discharged, enabling the liquid to pass through the micropores in the membrane walls of the hollow fiber liquid filter membranes from the separation cavity between the melt-blown fiber filter element and the hollow fiber liquid filtering part under the action of suction force and enter the inner cavities of the hollow fiber liquid filter membranes, and blocking the microorganisms and the bacteria in the liquid outside the membrane walls without entering the inner cavities of the hollow fiber liquid filter membranes by utilizing the micropores in the membrane walls of the hollow fiber liquid filter membranes, so that filtration is completed; and
S5, discharging: discharging the liquid from the capillary liquid outlet holes in the liquid filtering hollow fiber bundle composed of a plurality of hollow fibers for filtering liquid in the hollow fiber liquid filtering part, and converging the liquid to be discharged from the liquid outlet in the liquid outlet end so as to be drunk or collected and stored by the user.

12. The use method according to claim 11, characterized in that the use method also comprises a back-flushing step, before filtration is ended, positive pressure is provided for the liquid outlet nozzle in a manner of blowing by the user or reversing by the external suction device and the like, and the liquid impacts the liquid filtering hollow fibers from the liquid outlet through the capillary liquid outlet holes, so that back flushing of the liquid filtering hollow fibers and the melt-blown fiber filter element is realized by clean liquid; or when the device is not used, the user can blow water left in the device out of the liquid inlet through an air blowing method, and the water can also be thrown out of the device through a swinging action.

13. The use method according to claim 11, characterized in that the liquid is water comprising particles and micrograms.
